(19) United States
(12) Patent Application Publication
(10) Pub. No.: US 2012/0026621 A1
(43) Pub. Date: Feb. 2, 2012

(54) MAGNETIC DISK APPARATUS AND SLIDER CONTROL METHOD

(75) Inventor: Masakazu ABE, Tokyo (JP)

(73) Assignee: Kabushiki Kaisha Toshiba, Tokyo (JP)

(21) Appl. No.: 13/047,586

(22) Filed: Mar. 14, 2011

(30) Foreign Application Priority Data
Jul. 30, 2010 (JP) 2010-172752

(51) Int. Cl. G11B 21/02; G11B 27/36

(52) U.S. Cl. 360/31; 360/75; G9B/21.003; G9B/27.052

(57) ABSTRACT

In one embodiment, there is provided a magnetic disk apparatus. The apparatus includes: a recording medium including a recording surface for recording information; a slider including a head configured to write information to the recording medium or read information from the recording medium; and a controller configured to control moving of the slider so as to remove a substance adhered to the slider and such that the slider is stopped at a position where the slider and the recording surface of the recording medium do not interfere with each other after the slider is moved at a given velocity or acceleration.

### CROSS-REFERENCE TO RELATED APPLICATION

This application claims priority from Japanese Patent Application No. 2010-172752, filed on Jul. 30, 2010, the entire contents of which are hereby incorporated by reference.

### BACKGROUND

1. Field

Embodiments described herein generally relate to a magnetic disk apparatus and a slider control method.

2. Description of the Related Art

In recent years, capacities of magnetic disk apparatuses have been increased due to higher recording densities and/or higher track densities of magnetic disks serving as recording media. With higher recording densities and/or higher track densities of magnetic disks, precision and reliability of control for reading or writing information are desired to be improved more than ever.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram illustrating a configuration of a magnetic disk apparatus according to the present embodiment;

FIG. 2 is a schematic diagram describing a mechanism structure included in a HDD;

FIGS. 3A and 3B are schematic diagrams illustrating a state in which adherent substances are adhered to a slider;

FIG. 4 is a schematic diagram describing a first example of an operation for removing an adherent substance adhered to the slider;

FIG. 5 is a schematic diagram describing a second example of an operation for removing an adherent substance adhered to the slider;

FIG. 6 is a schematic diagram describing a third example of an operation for removing an adherent substance adhered to the slider; and

FIG. 7 is a flow chart describing timing with which a removal operation for removing an adherent substance adhered to the slider is performed.

### DETAILED DESCRIPTION

According to exemplary embodiments of the present invention, there is provided a magnetic disk apparatus. The apparatus includes: a recording medium including a recording surface for recording information; a slider including a head configured to write information to the recording medium or read information from the recording medium; and a controller configured to control moving of the slider so as to remove a substance adhered to the slider and such that the slider is stopped at a position where the slider and the recording surface of the recording medium do not interfere with each other after the slider is moved at a given velocity or acceleration.

Hereinafter, the present embodiment will be described with reference to the drawings.

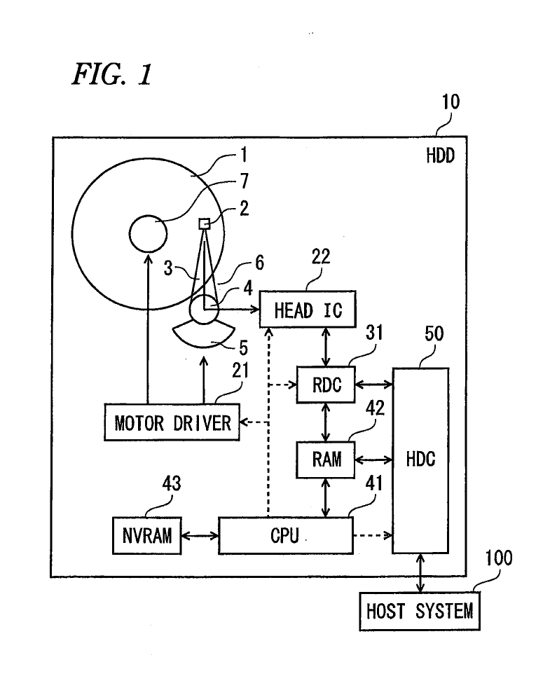

FIG. 1 is a block diagram illustrating a configuration of a magnetic disk apparatus (hereinafter also referred to as a “HDD”) 10 according to the present embodiment. The HDD 10 is an electronic device that communicates with a host system 100.

The HDD 10 according to the present embodiment has a mechanism structure including a magnetic disk 1, a slider 2, an arm 3, a bearing 4; a VCM (Voice Coil Motor) 5 and an SPM (Spindle Motor) 7. The slider 2, the arm 3, the bearing 4 and the VCM 5 integrally constitute a structure that is referred to as an HSA (Head Stack Assembly) 6. Further, the HDD 10 includes functional blocks of a circuit system, such as a motor driver 21, a head IC 22, a read/write channel IC (hereinafter also referred to as an “RDC”) 31, a CPU 41, a RAM 42, an NVRAM 43, and an HDC (Hard Disk Controller) 50.

The HDD 10 according to the present embodiment supplies a driving current to the VCM 5, thereby rotating the HSA 6 using the bearing 4 as a rotation center. A rotation angle of the HSA 6 is limited to a given range. An adherent substance might be adhered to a part of the slider 2. The HDD 10 supplies a driving current to the VCM 5 and thus rotates the HSA 6, thereby removing the adherent substance from the slider 2. In many cases, the adherent substance is lubricating oil or the like applied onto the magnetic disk.

The magnetic disk 1 is fixed to the SPM 7, and is rotated by driving the SPM 7. At least one surface of the magnetic disk 1 serves as a recording surface on which information is magnetically recorded.

The slider 2 is provided at one end of the arm 3 so as to be associated with the recording surface of the magnetic disk 1. The slider 2 reads a signal magnetically recorded on the recording surface of the magnetic disk 1, and outputs the read signal to the head IC 22. Furthermore, in response to a write signal (write current) fed from the head IC 22, the slider 2 magnetically records information on the recording surface of the magnetic disk 1. The slider 2 slides over the recording surface of the magnetic disk 1.

The arm 3 is provided at its one end with the slider 2. In response to supply of a driving current to the VCM 5, the arm 3 rotates using the bearing 4 as a rotation center, and moves the slider 2 radially over the recording surface of the magnetic disk 1.

The bearing 4 serves as the rotation center of the HSA 6 by inserting a shaft (not illustrated) to be fixed to an enclosure of the HDD 10.

The VCM 5 is driven in response to a driving signal (current) supplied from the motor driver 21, thereby rotating the arm 3.

The HSA 6 is the structure integrally constituted by the slider 2, the arm 3, the bearing 4 and the VCM 5. In response to supply of a driving current to the VCM 5, the HSA 6 moves the slider 2, provided at one end of the arm 3, using the bearing 4 as the rotation center. The rotation angle of the HSA 6 is limited to a given range.

The SPM 7 is driven in response to a driving signal (current) supplied from the motor driver 21, thereby rotating the magnetic disk 1.

Based on control carried out by the CPU 41, the motor driver 21 supplies, to the VCM 5 and the SPM 7, the driving signals for driving the VCM 5 and the SPM 7, respectively.

The head IC 22 amplifies a signal fed from a read head (not illustrated) provided at the slider 2, and outputs, as read information, the amplified signal to the RDC 31. Further, the head IC 22 outputs, to a write head (not illustrated) provided at the slider 2, a write signal (write current) responsive to recording information fed from the RDC 31.

The RDC 31 performs a given process on the read information, fed from the head IC 22, to decode the read information, and outputs, as transfer information, the decoded information to the HDC 50. Furthermore, the RDC 31 performs a given process on information, which has been fed from the HDC 50 and should be recorded, to encode the information, and outputs, as recording information, the encoded information to the head IC 22. The RDC 31 utilizes the RAM 42 as a work memory in performing the given processes for encoding and decoding.

In accordance with a program stored in the NVRAM 43, the CPU 41 controls each block included in the HDD 10. The CPU 41 is a processor for controlling rotational operations of the VCM 5 and the SPM 7. The CPU 41 utilizes the RAM 42 as a work memory in executing the program. In the present embodiment, with the aim of removing an adherent substance adhered to the slider 2, the CPU 41 performs control so as to rotate the VCM 5 to a position at which the adherent substance does not interfere with the recording surface of the magnetic disk 1. This control is carried out using given timing as a trigger.

The RAM 42 is a work memory for the RDC 31, the CPU 41 and the HDC 50. As the RAM 42, a DRAM serving as a volatile memory may be applied.

The NVRAM 43 is a nonvolatile memory for storing a program executed by the CPU 41. The program stored in the NVRAM 43 is updatable.

The HDC 50 carries out a communication process for transmitting and receiving information to and from the host system 100. The HDC 50 performs a given process on the transfer information, fed from the RDC 31, to encode the transfer information, and transmits, as transmission information, the encoded information to the host system 100. Moreover, the HDC 50 performs a given process on reception information, received from the host system 100, to decode the reception information, and outputs, as information that should be recorded, the decoded information to the RDC 31. For example, the HDC 50 carries out the communication process with the host system 100 in accordance with a SATA (Serial Advanced Technology Attachment) standard.

With the above-described configuration, an adherent substance adhered to the slider 2 is removed using a plurality of blocks included in the HDD 10 according to the present embodiment. Accordingly, in the HDD 10 according to the present embodiment, an adherent substance adhered to the slider is allowed to be effectively removed without being influenced by the recording surface of the magnetic disk. Theses processes are realized by carrying out a plurality of processes mainly by the CPU 41.

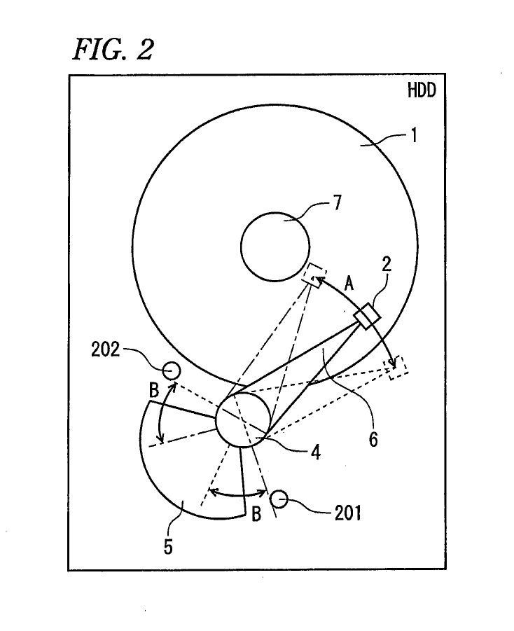

Next, referring to FIG. 2, the mechanism structure included in the HDD 10 will be schematically described.

FIG. 2 is a schematic diagram describing the mechanism structure included in the HDD 10.

As mentioned above, the HSA 6 moves the slider 2, provided at one end of the arm 3, using the bearing 4 as the rotation center. The slider 2 is moved within a range indicated by an arrow A due to the rotation of the HSA 6. The slider 2 is moved in such a manner that it slides over the recording surface of the magnetic disk 1 within an area of part of this range, but is moved between positions at which the slider 2 does not interfere with the recording surface of the magnetic disk 1 within the other area of this range.

Furthermore, in response to the supplied driving current, the VCM 5 rotates the arm 3 and the slider 2, provided at one end of the arm 3, using the bearing 4 as the rotation center as mentioned above. Moreover, the VCM 5 itself also rotates within a range indicated by arrows B using the bearing 4 as the rotation center. In other words, the movement range of the VCM 5 is limited to the range indicated by the arrows B.

With the slider 2 moved to an inner periphery of the magnetic disk 1, the HSA 6 is moved to a position indicated by alternate long and short dashed lines. In this case, the VCM 5 partially abuts against an inner periphery stopper 201, thereby restricting the movement range of the VCM 5. Also in this case, the slider 2 is moved to a position which corresponds to that of the SPM 7 provided at the inner periphery of the magnetic disk 1 and at which the slider 2 does not interfere with the recording surface of the magnetic disk 1.

On the other hand, with the slider 2 moved to an outer periphery of the magnetic disk 1, the HSA 6 is moved to a position indicated by dotted lines. In this case, the VCM 5 partially abuts against an outer periphery stopper 202, thereby restricting the movement range of the VCM 5. Also in this case, the slider 2 is moved to a position which corresponds to the outer periphery of the magnetic disk 1 and at which the slider 2 does not interfere with the recording surface of the magnetic disk 1.

It should be noted that the VCM 5 will not partially abut against the inner periphery stopper 201 or the outer periphery stopper 202 within the range in which the slider 2 is moved between positions located at the recording surface of the magnetic disk 1.

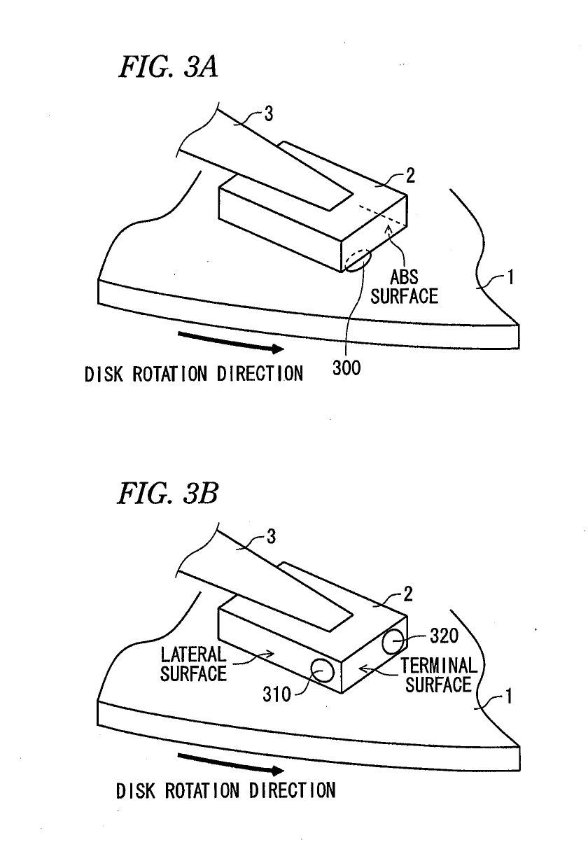

Next, referring to FIGS. 3A and 3B, a state in which adherent substances 300, 310 and 320 are adhered to the slider 2 will be now described.

FIGS. 3A and 3B are schematic diagrams illustrating the state in which the adherent substances 300, 310 and 320 are adhered to the slider 2.

As illustrated in the schematic diagram provided in FIG. 3A, the arm 3 is provided at its one end with the slider 2. Of a plurality of surfaces of the slider 2, the surface thereof opposed to the recording surface of the magnetic disk 1 will be referred to as an “ABS” surface. Upon adhesion of the adherent substance 300 to the ABS surface, the adherent substance 300 might interfere with a read head (not illustrated) or write head (not illustrated) provided at the ABS surface likewise. In this case, the property of reading or writing information from or to the magnetic disk 1 is changed. Besides, the ABS surface is provided with a groove structure through which the slider 2 slides over the recording surface of the magnetic disk 1 with a given levitation amount from the recording surface. The levitation property of the slider 2 might be changed due to the adherent substance 300 adhered to the ABS surface.

Further, as illustrated in the schematic diagram provided in FIG. 3B, the adherent substance 310 might be adhered to a lateral surface of the slider 2. Moreover, the adherent substance 320 might be adhered to a terminal surface of the slider 2.

As described above, adherent substances might be adhered to various positions of the slider 2, but the positions to which adherent substances are adhered have a certain tendency. With the magnetic disk 1 rotated, convection occurs between the recording surface of the magnetic disk 1 and the ABS surface of the slider 2 along a disk rotation direction. Furthermore, convection flowing from the ABS surface of the slider 2 to the terminal surface thereof or to the lateral surface thereof also occurs. Accordingly, adherent substances tend to adhere to downstream positions of the slider 2 in the disk rotation direction.

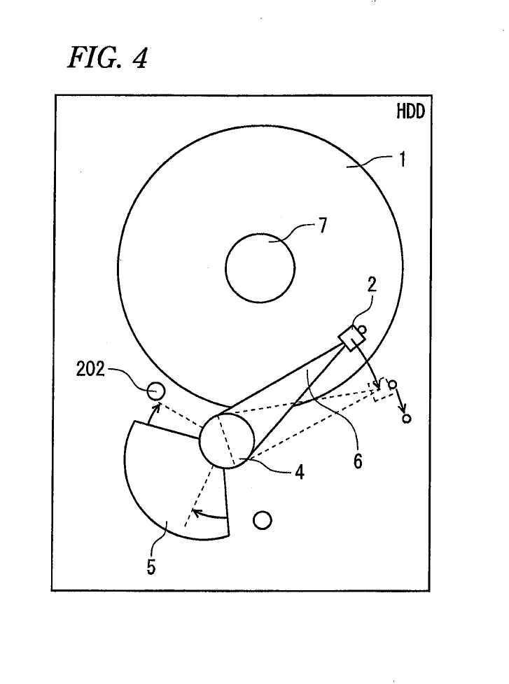

Next, referring to FIG. 4, a first example of an operation for removing an adherent substance adhered to the slider 2 will be described.

FIG. 4 is a schematic diagram for describing the first example of an operation for removing an adherent substance adhered to the slider 2.

The schematic diagram provided in FIG. 4 illustrates the operation for throwing out an adherent substance, adhered to the slider 2, to an outer peripheral region of the magnetic disk 1, thereby removing the adherent substance.

In this example, in order to remove the adherent substance adhered to the slider 2, a polar driving current for moving the slider 2 toward an outer periphery of the magnetic disk 1 is supplied to the VCM 5. Concurrently with the movement of the slider 2 toward the outer periphery at a given velocity or acceleration, the VCM 5 is rotated in a direction, in which the VCM 5 is brought close to the magnetic disk 1, around the bearing 4. Upon rotation of the VCM 5 to a given position, the VCM 5 partially abuts against the outer periphery stopper 202. That is to say, the rotation of the VCM 5 is stopped at a position at which the VCM 5 partially abuts against the outer periphery stopper 202.

Concurrently with the stop of rotation of the VCM 5, the movement of the slider 2 is also stopped. In this case, the adherent substance adhered to the slider 2 maintains the given velocity or acceleration toward the outer periphery of the magnetic disk 1 due to inertia resulting from the movement of the slider 2 until the slider 2 stops. In other words, upon abutment of the VCM 5 against the outer periphery stopper 202 in a state where the slider 2 is moved and upon stop of the slider 2, a force is applied to the slider 2 in a direction opposite to that of a force applied thereto up to that time. On the other hand, the adherent substance keeps maintaining a force applied in the direction in which the slider 2 has been moved.

Then, the adherent substance, which is not fixed to the slider 2, is thrown out to the outer periphery of the magnetic disk 1 due to the inertia (or force) resulting from the movement of the slider 2. Thus, the adherent substance adhered to the slider 2 is removed. The velocity or acceleration resulting from the movement of the slider 2 in this operation must be sufficient to throw out the adherent substance from the slider 2.

With the above-described operation, the adherent substance adhered to the slider 2 is thrown out to a region where the adherent substance will not interfere with the recording surface of the magnetic disk 1. Accordingly, in the HDD 10 according to the present embodiment, the adherent substance adhered to the slider is allowed to be effectively removed without being influenced by the recording surface of the magnetic disk.

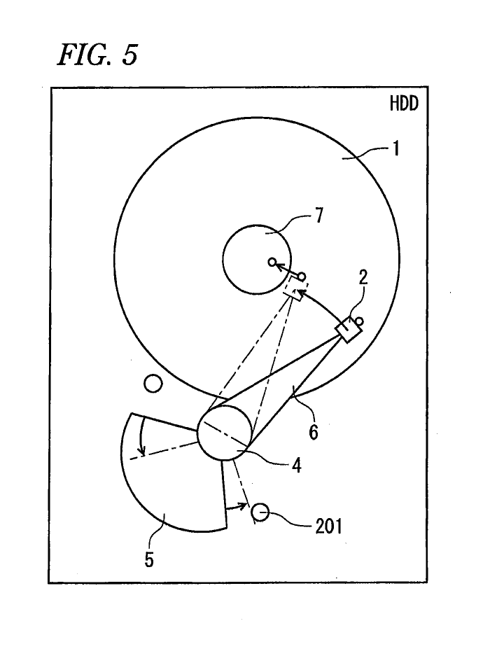

Next, referring to FIG. 5, a second example of an operation for removing an adherent substance adhered to the slider 2 will be described.

FIG. 5 is a schematic diagram describing the second example of an operation for removing an adherent substance adhered to the slider 2.

The schematic diagram provided in FIG. 5 illustrates the operation for throwing out an adherent substance, adhered to the slider 2, to an inner peripheral region of the magnetic disk 1, thereby removing the adherent substance.

In this example, in order to remove the adherent substance adhered to the slider 2, a polar driving current for moving the slider 2 toward an inner periphery of the magnetic disk 1 is supplied to the VCM 5. Concurrently with the movement of the slider 2 toward the inner periphery at a given velocity or acceleration, the VCM 5 is rotated in a direction, in which the VCM 5 goes away from the magnetic disk 1, around the bearing 4. Upon rotation of the VCM 5 to a given position, the VCM 5 partially abuts against the inner periphery stopper 201. That is to say, the rotation of the VCM 5 is stopped at a position at which the VCM 5 partially abuts against the inner periphery stopper 201.

Concurrently with the stop of rotation of the VCM 5, the movement of the slider 2 is also stopped. In this case, the adherent substance adhered to the slider 2 maintains the given velocity or acceleration toward the inner periphery of the magnetic disk 1 due to inertia resulting from the movement of the slider 2 until the slider 2 stops. In other words, upon abutment of the VCM 5 against the inner periphery stopper 201 in a state where the slider 2 is moved and upon stop of the slider 2, a force is applied to the slider 2 in a direction opposite to that of a force applied thereto up to that time. On the other hand, the adherent substance keeps maintaining a force applied in the direction in which the slider 2 has been moved.

Then, the adherent substance, which is not fixed to the slider 2, is thrown out to the inner periphery of the magnetic disk 1 due to the inertia (or force) resulting from the movement of the slider 2. Thus, the adherent substance adhered to the slider 2 is removed. The velocity or acceleration resulting from the movement of the slider 2 in this operation must be sufficient to throw out the adherent substance from the slider 2. It should be noted that when the VCM 5 is located at a position at which the VCM 5 partially abuts against the inner periphery stopper 201, a position located inwardly of the position of the slider 2 with respect to the magnetic disk 1 is typically not located at the recording surface.

With the above-described operation, the adherent substance adhered to the slider 2 is thrown out to a region where the adherent substance will not interfere with the recording surface of the magnetic disk 1. Accordingly, in the HDD 10 according to the present embodiment, the adherent substance adhered to the slider is allowed to be effectively removed without being influenced by the recording surface of the magnetic disk.

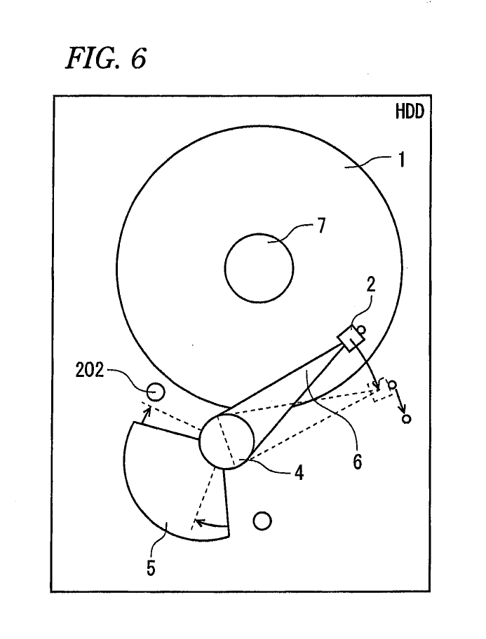

Next, referring to FIG. 6, a third example of an operation for removing an adherent substance adhered to the slider 2 will be described.

FIG. 6 is a schematic diagram for describing the third example of an operation for removing an adherent substance adhered to the slider 2.

The schematic diagram provided in FIG. 6 illustrates the operation for throwing out an adherent substance, adhered to the slider 2, to an outer peripheral region of the magnetic disk 1, thereby removing the adherent substance. The third example is similar to the first example, described with reference to FIG. 4, in that the adherent substance is thrown out to an outer peripheral region of the magnetic disk 1, but is different from the first example in that the slider 2 is stopped at a different position for removing the adherent substance. Further, although the example in which the adherent substance is thrown out to an outer peripheral region of the magnetic disk 1 will be described with reference to this schematic diagram, the third example may also be applied to an example in which the adherent substance is thrown out to an inner peripheral region of the magnetic disk 1.

In this example, in order to remove the adherent substance adhered to the slider 2, a polar driving current for moving the slider 2 toward the outer periphery of the magnetic disk 1 is supplied to the VCM 5. Concurrently with the movement of the slider 2 toward the outer periphery at a given velocity or acceleration, the VCM 5 is rotated in a direction, in which the VCM 5 is brought close to the magnetic disk 1, around the bearing 4. Upon rotation of the VCM 5 to a given position, the supply of the driving current to the VCM 5 is stopped, and the VCM 5 is stopped. At this position, the VCM 5 does not partially abut against the outer periphery stopper 202.

Concurrently with the stop of rotation of the VCM 5, the movement of the slider 2 is also stopped. In this case, the adherent substance adhered to the slider 2 maintains the given velocity or acceleration toward the outer periphery of the magnetic disk 1 due to inertia resulting from the movement of the slider 2 until the slider 2 stops. In other words, upon stop of the slider 2 before the VCM 5 abuts against the outer periphery stopper 202 in a state where the slider 2 is moved, a force is applied to the slider 2 in a direction opposite to that of a force applied thereto up to that time. On the other hand, the adherent substance keeps maintaining a force applied in the direction in which the slider 2 has been moved.

Then, the adherent substance, which is not fixed to the slider 2, is thrown out to the outer periphery of the magnetic disk 1 due to the inertia (or force) resulting from the movement of the slider 2. Thus, the adherent substance adhered to the slider 2 is removed. The velocity or acceleration resulting from the movement of the slider 2 in this operation must be sufficient to throw out the adherent substance from the slider 2.

With the above-described operation, the adherent substance adhered to the slider 2 is thrown out to a region where the adherent substance will not interfere with the recording surface of the magnetic disk 1. Accordingly, in the HDD 10 according to the present embodiment, the adherent substance adhered to the slider is allowed to be effectively removed without being influenced by the recording surface of the magnetic disk.

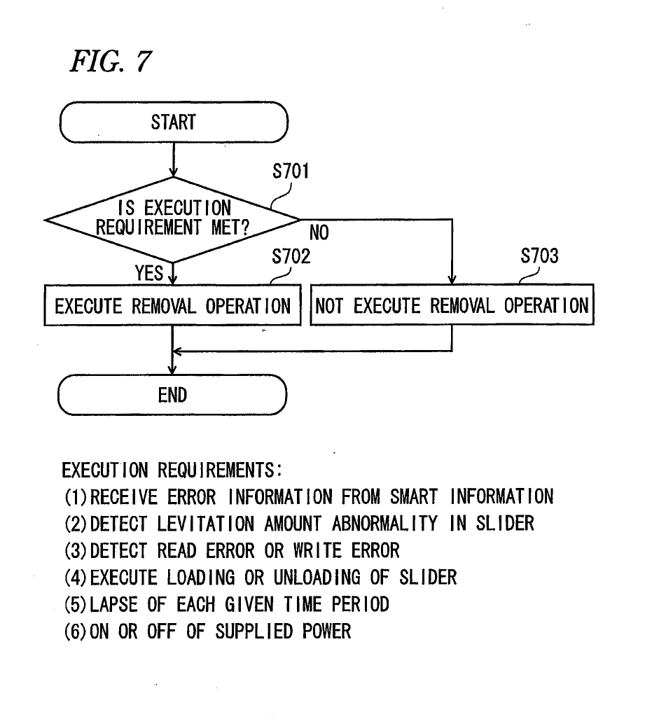

Next, referring to FIG. 7, timing with which a removal operation for removing an adherent substance adhered to the slider 2 is performed will be described.

FIG. 7 is a flow chart for describing the timing with which the removal operation for removing an adherent substance adhered to the slider 2 is performed.

Processing to be performed in accordance with the flow chart illustrated in FIG. 7 is carried out by a program executed by the CPU 41 illustrated in FIG. 1.

First, the CPU 41 determines whether or not a current state of the HDD 10 or an event that has occurred meets an execution requirement for the adherent substance removal operation (S701). When the execution requirement is met (i.e., when the answer is Yes in S701), the removal operation is executed (S702). On the other hand, when the execution requirement is not met (i.e., when the answer is No in S701), no removal operation is executed (S703). In either case, i.e., when the removal operation is executed or when no removal operation is executed, this processing is brought to an end. That is to say, this processing is processing for determining whether or not the removal operation should be executed.

Execution requirements for the adherent substance removal operation will be described below. These execution requirements are described by way of example, and the present invention is not limited to these requirements.

(1) Reception of Error Information from SMART Information

This requirement is met upon detection that error information is recorded in SMART information. It is assumed that a cause of occurrence of this error is adhesion of an adherent substance to the slider 2

(2) Detection of Levitation Amount Abnormality in Slider

In some cases, a levitation amount of the slider 2 is measured based on a servo signal read by the read head (not illustrated) included in the slider 2 and/or information such as the level of the read signal. This requirement is met upon detection that the levitation amount indicates an abnormal value. It is assumed that a cause of occurrence of this levitation amount abnormality is adhesion of an adherent substance to the slider 2. The measurement of a levitation amount is applicable to various embodiments where the measurement is executed as special-purpose processing, where the measurement is executed while information is read or written from or to the magnetic disk 1, etc.

(3) Detection of Read Error or Write Error

This requirement is met upon detection of a read error or a write error while information is read or written from or to the magnetic disk. It is assumed that a cause of occurrence of this error is adhesion of an adherent substance to the slider 2. When this requirement is met, the removal operation may be executed as part of a retry process incident to detection of a read error or a write error.

(4) Execution of Loading or Unloading of Slider

This requirement is met prior to or subsequent to execution of an operation for loading or unloading the slider 2.

(5) Each Given Time Period

This requirement is met when a given time period is counted by the CPU 41. The CPU 41 is capable of counting a given time period interval based on a clock signal with a given frequency.

(6) ON or OFF of Supplied Power

This requirement is met after power supplied to the HDD 10 is turned ON or before power supplied to the HDD 10 is turned OFF.

As mentioned above, the removal operation for removing an adherent substance adhered to the slider 2 is performed with the timing of event occurrence or the timing of detection in accordance with the various execution requirements, thereby allowing the adherent substance adhered to the slider to be effectively removed with suitable timing.

As described thus far, according to the present embodiment, the driving current supplied to the VCM 5 is controlled, thereby allowing the adherent substance adhered to the slider 2 to be easily removed. Furthermore, the driving current is controlled such that the interference of the slider 2 and the recording surface of the magnetic disk 1 with each other is avoided, thereby allowing the adherent substance adhered to the slider to be effectively removed without being influenced by the recording surface of the magnetic disk 1. Moreover, the adhesion of the adherent substance to the slider 2 is detected based on a given requirement, thereby allowing the adherent substance adhered to the slider to be effectively removed with suitable timing. Accordingly, in the HDD 10 according to the present embodiment, the adherent substance adhered to the slider is allowed to be effectively removed without being influenced by the recording surface of the magnetic disk.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

What is claimed is:

1. A magnetic disk apparatus comprising:
a recording medium comprising a recording surface for recording information;
a slider comprising a head configured to write information to the recording medium or read information from the recording medium; and
a controller configured to control moving of the slider so as to remove a substance adhered to the slider and such that the slider is stopped at a position where the slider and the recording surface of the recording medium do not interfere with each other after the slider is moved at a given velocity or acceleration.

2. The apparatus of claim 1, further comprising:
a head stack assembly configured to move the slider such that the slider floats above the recording surface with a given distance therebetween;
a voice coil motor configured to rotate the head stack assembly around a given axis,
wherein the slider is moved at the given velocity or acceleration by an electric current supplied to the voice coil motor.

3. The apparatus of claim 2, further comprising:
an inner periphery stopper that limits a rotation range of the voice coil motor so as to stop the slider at a position where the slider and an inner periphery of the recording surface do not interfere with each other; and
an outer periphery stopper that limits the rotation range of the voice coil motor so as to stop the slider at a position wherein the slider and an outer periphery of the recording surface do not interfere with each other,
wherein the slider is stopped at the position where the slider and the recording surface of the recording medium do not interfere with each other by the inner periphery stopper or the outer periphery stopper.

4. The apparatus of claim 1,
wherein the controller is configured to control moving of the slider based on any one of the following requirements:
reception of error information from SMART information;
detection of a levitation amount abnormality in the slider;
detection of a read error in reading information from the recording medium;
detection of a write error in writing information to the recording medium;
execution of loading or unloading of the slider;
a lapse of each given time period; and
ON or OFF of power.

5. A slider control method using the magnetic disk apparatus which comprises: a recording medium comprising a recording surface for recording information; a slider comprising a head configured to write information to the recording medium or read information from the recording medium, the method comprising:
moving the slider at the given velocity or acceleration; and
stopping the slider at the position where the slider and the recording surface of the recording medium do not interfere with each other so as to remove the substance adhered to the slider
